(19) United States
(12) Patent Application Publication
(10) Pub. No.: US 2014/0350910 A1
(43) Pub. Date: Nov. 27, 2014

(54) TIME-SEGMENTED STATISTICAL I/O MODELING

(71) Applicants: RUKMA A. TALWADKER, Bangalore (IN); KALADHAR VORUGANTI, San Jose, CA (US)

(72) Inventors: RUKMA A. TALWADKER, Bangalore (IN); KALADHAR VORUGANTI, San Jose, CA (US)

(21) Appl. No.: 13/901,233

(22) Filed: May 23, 2013

(51) Int. Cl. G06F 17/50

(52) U.S. Cl. CPC G06F 17/5009
USPC 703/21

(57) ABSTRACT

A system includes tracing logic to parse trace information into time varying segments and model traces based on segments of time varying I/O (input/output) and/or workload behavior. The logic can detect segments that represent statistically similar system behavior and reduce the number of segments based on detecting segments representing similar system behavior. The logic can leverage Mutual Information techniques to eliminate redundant workload dimensions and build a concise workload model. The logic can also use HAC to segregate similar workload patterns represented by multiple non-redundant workload attributes. The logic can use ePDF to regenerate distributions of workload attribute values during trace regeneration. The logic can generate segment models from the segments, which can be combined into a test trace that represents a period of system behavior for simulation. The logic can allow combining the segment models in different patterns to simulate behavior not observed in the original trace information.

### FIELD

Embodiments described are related generally to tracing, and embodiments described are more particularly related to time-segmenting traces for I/O modeling.

### COPYRIGHT NOTICE/PERMISSION

Portions of the disclosure of this patent document can contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright© 2013, NetApp, Inc., All Rights Reserved.

### BACKGROUND

Cloud infrastructures are increasingly common, where users remotely access storage resources, which appear to the user as a single virtual “cloud” of available storage. Increasingly, storage system designs improve the user experience of interfacing with virtualized storage resources. However, virtualized storage resources or cloud infrastructures limit an understanding of how systems operate at the storage layer. Tracing allows an administrator to capture a wealth of information about system workloads and system behavior based on the workloads. Such tracing typically includes I/O tracing. Trace replay (e.g., replaying I/O) provides an opportunity for the administrator to observe system behavior and make decisions for improving system workload performance and filesystem design.

However, I/O traces tend to be bulky, requiring large amounts of storage. Additionally, the traces are not typically directly interpretable by an administrator, but are typically replayed for the administrator to observe behavior. Furthermore, traces are traditionally non-scalable—an administrator traditionally is only able to model and/or replay system behavior that has been monitored and recorded in a trace. For example, I/O replay has a limited scope that allows an exact replay where system configuration and state has been recreated to the original configuration and state of the recorded trace. While numerous simulation benchmarks exist that can provide a good simulation, each requires an understanding of the characteristics of the workloads, which is increasingly obscured due to server virtualization and multitenancy. Thus, simulation benchmarks are increasingly drifting away from accurate representation of real system workloads in certain systems.

### BRIEF DESCRIPTION OF THE DRAWINGS

The following description includes discussion of figures having illustrations given by way of example of implementations of embodiments described. The drawings should be understood by way of example, and not by way of limitation. As used herein, references to one or more “embodiments” are to be understood as describing a particular feature, structure, or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 is a block diagram of an embodiment of a system having management system including trace modeling with time varying segments.

FIG. 2 is a block diagram of an embodiment of a trace modeling architecture.

FIG. 3 is a block diagram of an embodiment of an architecture for trace modeling and playback.

FIG. 4 is a pseudocode representation of an embodiment of a trace model generation.

FIG. 5A is a flow diagram of an embodiment of a process for modeling a trace with time varying segments.

FIG. 5B is a flow diagram of an embodiment of a process for replaying a trace with time varying segments.

FIG. 6A illustrates a network storage system in which an architecture for trace modeling with time varying segments can be implemented.

FIG. 6B illustrates a distributed or clustered architecture for a network storage system in which an architecture for trace modeling with time varying segments can be implemented in an alternative embodiment.

FIG. 7 is a block diagram of an illustrative embodiment of an environment of FIGS. 6A and 6B in which an architecture for trace modeling with time varying segments can be implemented.

FIG. 8 illustrates an embodiment of the storage operating system of FIG. 7 in which an architecture for trace modeling with time varying segments can be implemented.

Descriptions of certain details and embodiments follow, including a description of the figures, which can depict some or all of the embodiments described below, as well as discussing other potential embodiments or implementations of the inventive concepts presented herein.

### DETAILED DESCRIPTION

A system monitors its workload behavior and generates a trace to represent the workload behavior of the system. The trace can be thought of as an original trace, which identifies the operations of the system over a period of time. As described below, the system includes tracing logic to parse trace information from the original into time varying segments and model the original trace and/or variations of the original trace based on the segments. When considering the segments as sequential representations of how the system workload behavior changes over a period of time of the original trace, each time varying segment represents workload behavior different from adjacent segments. The system can detect segments that represent statistically similar or the same system behavior as other segments. It will be understood that while each segment is different than adjacent segments, multiple non-adjacent segments may represent statistically the same or similar system behavior.

When the system detects segments representing similar system behavior, it can eliminate one or more segments, reducing the set of segments used to represent all workload behaviors of the monitored system. The system stores segment information or generates segment models from the segments. The amount of storage space needed to store segment information for all segments is less than the amount of storage space required for the original trace. In one embodiment, the system can combine the segment models into a test trace that represents system behavior for simulation. The test trace can represent, and be used to simulate, the original trace. In one embodiment, the system can combine the segment models into a test trace having different workload patterns that will simulate behavior not observed in the original trace.

The flexibility in creating test traces of different workload patterns allows system designers to simulate and observe system behaviors with varying workload scenarios (what-if scenarios for the system). In one embodiment, a system administrator and/or system designer can generate a test trace incorporating multiple variables to vary workload pattern scenarios. Example variables can include variable(s) to scale workload intensity up/down, replay actual workloads over a different (e.g., smaller/larger) storage space, scale multithreading levels in original workloads, or other variables for other scenarios. In one embodiment, the administrator (or system designer, quality tester, or other individual) can be said to generate a synthetic workload from the segments, which allows testing scenarios that an original workload trace cannot be modified to test. In one embodiment, all synthetic workloads are modeled to share key properties with the original workloads from which their models have been derived. Key properties can include read/write mix, sequential/random I/O percentages, number of workload streams, individual thread compute times, operation mix, operation interval times, I/O arrival times, and other properties.

In one embodiment, model generation logic can represent key properties as dimensions of a hierarchical Markov model. The Markov model is a standard tool used to represent workload behavior, but is limited by space and compute complexity. The Markov model requires exponentially more resources with increases in trace model size, number of trace parameters, and individual parameter ranges. In one embodiment, the system uniquely represents each workload or each time varying segment of the trace using only a few parameters, for example by using representative parameters or attributes to reduce the dimensionality. The remaining parameters can be represented as a function of other parameter(s).

In one embodiment, trace modeling logic extracts key parameters or key dimensions from a received trace. The trace can be, for example, a workload block (e.g., disk or SCSI) trace. In one embodiment, the trace modeling logic can represent the extracted key dimensions as a hierarchical Markov model. The Markov model can be thought of as a combination of several time varying segment models. The logic writes the resulting model (with all segments) to disk, where the entire resulting model is on the order of tens of kilobytes (e.g., approximately 10-20 KB) in size, as compared to the original traces that can be on the order of a gigabyte or more in size.

In one embodiment, the tracing modeling logic allows a trace user (e.g., an administrator, engineer, system designer, or other) to generate or reproduce traces with various what-if properties in the generated model. In one embodiment, the logic reduces dimensionality of the resulting model based on a Mutual Information approach. The Mutual Information approach is a statistical approach to determining a relationship between random variables. In one embodiment, the logic can employ statistical clustering and empirical probability distribution functions to reproduce various representative I/O properties of workload behavior. With such statistical tools, the tracing modeling logic can accurately reproduce workload bursts, preserve cache locality, and workload sequentiality. The logic can also reproduce identical workload patterns over a smaller storage footprint, as well as systematically simulate workload multithreading and workload multitenancy with no user intervention.

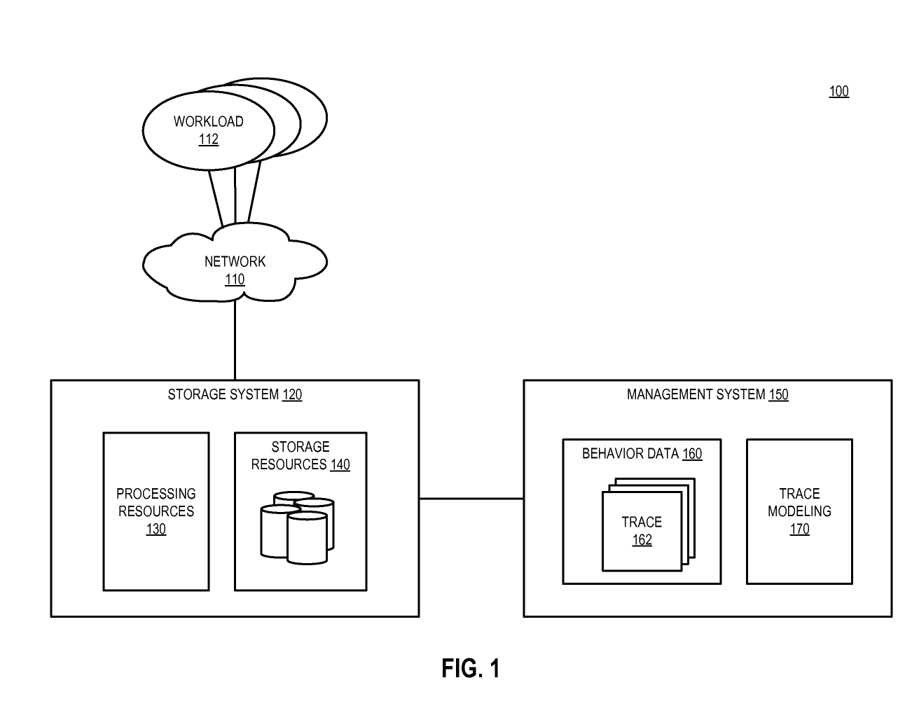

FIG. 1 is a block diagram of an embodiment of a system having management system including trace modeling with time varying segments. System 100 includes storage system 120 and management system 150. Storage system 120 typically includes a storage server coupled to storage devices. Processing resources 130 represent a storage server and/or other logic within the storage system used to receive and process access requests. Storage system 120 receives workloads 112 over network 110. Storage system 120 could also receive workloads from a local source (i.e., not over network 110), but most workloads come to storage system 120 over network 110.

Network 110 can be any type or combination of local area networks and/or wide area networks. Network 110 includes hardware devices to switch and/or route traffic from client devices to storage system 120, typically as sequences and/or groups of data packets. The hardware devices communicate over network channels via one or more protocols as is understood in the art. Workloads 112 represent requests or groups/sequences of requests generated by activities at the side of an end user, customer, or client. End users execute applications or other programs that make requests for data from storage system 120, which receives and processes the requests. The requests provide a load on the resources (e.g., bandwidth, storage resources 140, processing resources 130) of storage system 120, and are thus referred to as workloads 112.

Storage resources 140 include multiple storage devices (e.g., disks or drives) to which workloads 112 are directed. Workloads 112 generate I/O requests (read and/or write) to storage resources 140. Storage resource 140 can be managed in accordance with a filesystem and/or block-level management. Storage resources 140 include one more regions of storage blocks or groups of addresses. The addresses are commonly virtual addresses within data block access logic, which are mapped to physical addresses of the storage devices. Data block access logic can include a RAID (redundant array of independent disks or drives) manager or other block-level data manager.

System 100 includes management system 150, which includes behavior data 160 and trace modeling logic 170. Management system 150 monitors the operations of storage system 120, and records behavior data 160. Management system 150 includes one or more hardware interfaces to monitor behavior data 160. In one embodiment, one or more storage interfaces and/or network interfaces of storage system 120 can be considered part of management system 150 for purposes of recording trace data. The operations include the I/O operations generated by workloads 112, and can also include other processing operations. Behavior data 160 includes one or more traces 162, which represent the monitored and logged operations of storage system 120. Trace 162 indicates what operations of the storage system occurred in response to specific workloads 112. In one embodiment, trace 162 identifies I/O requests to storage system 120 for a period of time. In one embodiment, behavior data 160 can also include configuration data (not shown) that indicates a configuration of storage system 120 associated with various monitored periods of time.

In one embodiment, trace 162 includes a block trace. Each I/O request in a block trace can include several fields. Trace modeling logic 170 receives trace(s) 162 as input, derives key or primary characteristics of the workloads from the trace, and generates one or more models based on derived characteristics. In one embodiment, trace modeling logic 170 derives primary characteristics of the I/O directly from the fields in the I/O requests. The fields may include, but are not limited to, type of operation, offset in a LUN (logical unit number), I/O size, inter-arrival times between subsequent I/Os, or other fields, from which trace modeling logic 170 derives the primary characteristics or primary attributes.

In one embodiment, trace modeling logic 170 derives one or more secondary characteristics from I/O subsequences in the trace. Examples of secondary characteristics or secondary attributes can include, but are not limited to, run length of a sequence of I/O, burstiness of a sequence of I/O, number of concurrent threads, footprint of a thread, or other characteristics. Additionally, in one embodiment, trace modeling logic 170 can derive other attributes from the primary and secondary characteristics, such as run length distributions per thread, per thread sequentiality, per thread storage footprint, or other attributes.

A run refers to a sequence of I/Os for which the first byte of each I/O immediately follows the last byte of the previous I/O. Run length refers to a number of subsequent I/Os in a run. Average run length and average I/O size can be used to capture workload sequentiality. Sequentiality refers to a measure of average run length of a workload. A burst refers to any rigorous repetition of I/O activity. Burstiness refers to a measure of how much of a sequence of I/Os is generated in bursts. The burstiness can be indicated in terms of inter arrival times of requests or any other I/O attribute such as operation type. A workload's footprint refers to a set of location values (e.g., LUN offsets) that have been accessed by the workload. Each thread in a workload can have a distinct footprint. Seek distance refers to a ratio of sequentiality to randomness in a workload. Seek distance indicates a number of blocks to be skipped to satisfy the subsequent I/O request after serving the present request.

In one embodiment, each characteristic or parameter can be modeled as a signal. Other characteristics or parameters that can be modeled by trace modeling logic 170 as signals include seek distance within a LUN region, run length within a LUN region, LUN heat map, request think time, and inter-process think time. In one embodiment, trace modeling logic 170 partitions LUNs into regions based on a density of I/Os to the LUN for a workload. Seek distance within a LUN refers to capturing the seek distance between the beginning of an I/O and the most recent I/O within a LUN, which can help retain locality of access patterns within a region. Run length within a LUN region refers to accounting for consecutive I/Os that are sequential, which can retain sequentiality across workload streams. LUN heat map refers to capturing the temporal aspect of a workload by retaining information on the periodic shrinkage and growth in boundaries of mapped LUN areas accessed by a workload. Request think time refers to a time between arrival of consecutive request from the same process ID/client ID pair. Inter-process think time refers to a time between arrivals of corresponding requests from distinct processes, which can help model a degree of concurrency and simultaneous access during workload reproduction. The above examples of parameters or attributes are not intended as a complete list of all parameters that could be used. The model generation system can use any combination of the above parameters in addition to other workload related parameters not listed, but which would be understood by those skilled in the art, and which could be used in the same way described herein.

As indicated, trace modeling logic 170 can extract multiple characteristics or attributes from the I/O. Thus, each I/O can be represented as a multidimensional variable. In one embodiment, trace modeling logic 170 allows an unbounded number of dimensions, where each dimension indicates an attribute. In one embodiment, trace modeling logic 170 generates a trace model which represents each attribute as a random variable v_i, i being a dimension index. Each of the attributes is a categorical value (e.g., operation type), discrete value (e.g., I/O size), or continuous value (e.g., sequentiality, LUN offset, run length).

In one embodiment, each attribute has a different translation or mapping, which normalizes the attribute with respect to the other attributes. Normalization allows attributes of different value types (e.g., categorical, discrete, continuous) to be processed and/or evaluated as though of a similar type. Thus, in one embodiment, trace modeling logic 170 includes a mapping function Mf per random variable v_i to map values of the random variable to discretized representations (e.g., referred to as a “bucket”) usable by the logic. In one embodiment, each mapping function is completely independent of the others, and is based on properties of a specific random variable. System 100 can receive new mapping functions as extensions of a generic parent mapping function. The number of discretization buckets per dimension can vary based on the entropy of the random variable associated with the dimension. In one embodiment, trace modeling logic 170 includes generic logic that divides a random variable into a uniform number of fixed values if a specific mapping function, Mf, does not exist for the random variable. Thus, for example, every ith random variable of an I/O can be mapped to a bucket number between 1 to v_î{b}, where v_î{b} is the total number of buckets for random variable v_i.

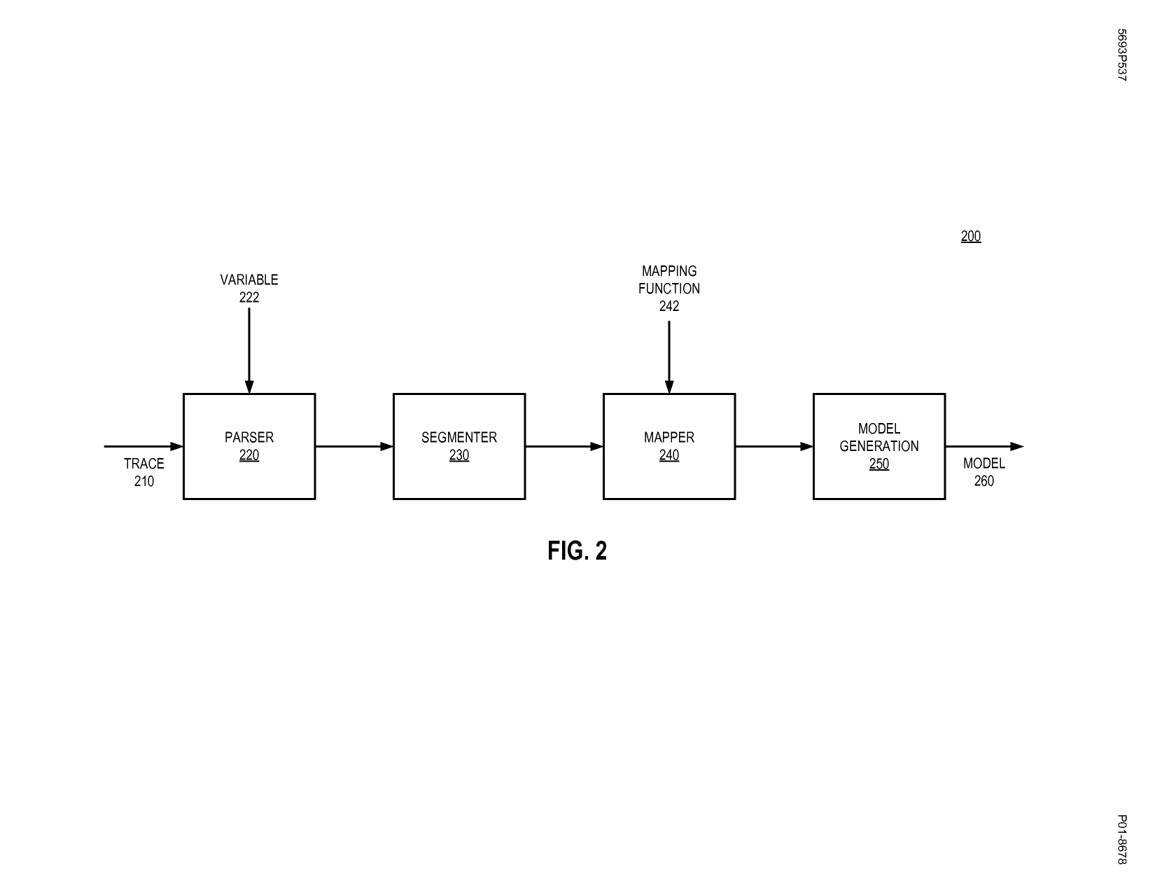

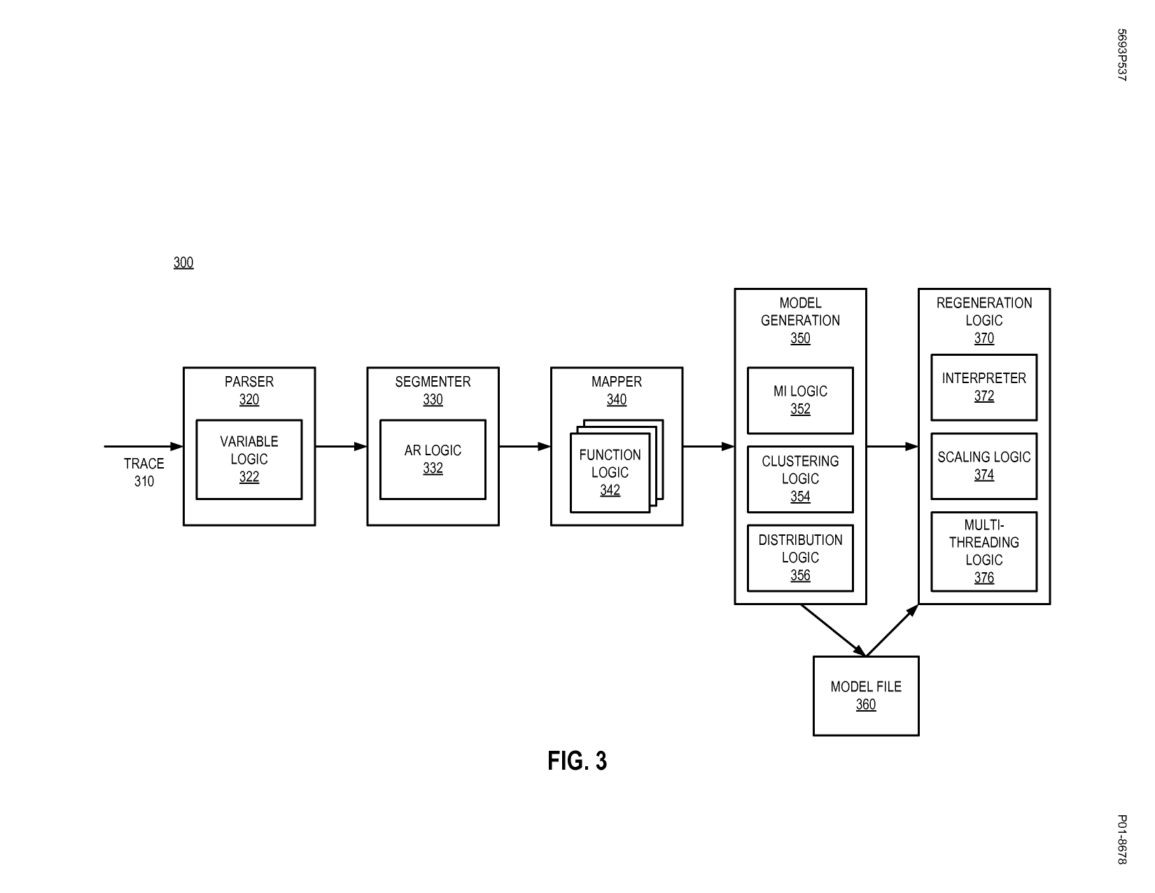

FIG. 2 is a block diagram of an embodiment of a trace modeling architecture. System 200 represents various components of an embodiment of the trace modeling architecture, and can be one example of an implementation of trace modeling logic 170 of FIG. 1. In one embodiment, system 200 may correspond to a Paragone architecture. System 200 more specifically illustrates model generation. System 300 of FIG. 3 (described below) more specifically illustrates model generation, with certain functional logic, as well as components that can also provide workload regeneration.

System 200 receives trace 210 at parser 220. Parser 220 separates or demarcates elements of data within trace 210. Parsing generally refers to separating or translating from one format into a format having indication symbols and/or a data structure that identifies different elements of data. In one embodiment, parser 220 translates a workload block trace of any format into a canonical comma separated file. In such a translation, each row can represent the values of each I/O parameter to be modeled. In one embodiment, parser 220 receives one or more variables or variable definitions 222 as input. Variable 222 represents input from a system administrator or other user of system 200 identifying what parameter(s) should be included in a resulting model 260. Thus, variable 222 can change how parser 220 parses trace 210.

Parser 220 sends the parsed trace file to segmenter 230, which can generate time varying segments from data identified by parser 220. It will be understood that the spatio-temporal attributes of a trace vary over time. The time variance can be macro time variance or micro time variance. Micro time variance refers to changes over time representing variations in workload behavior of the same operation and/or workload. Macro time variance refers to changes over time that indicate a change of operation and/or workload. Trace 210 includes time varying behavior identified by changes in attributes of the trace over time. Segmenter 230 receives the parsed trace as input and computes what elements of the trace indicate different time varying segments of the trace workload behavior.

Segmenter 230 employs statistical analysis of the parsed trace to determine a statistical distribution of behavior indicated in the data. Thus, in one embodiment, system 200 ignores micro variations in workload behavior, and generates a model for time varying segments that indicate a change of operation and/or workload. For example, segmenter 230 can use any of a variety of statistical models to calculate autoregression coefficients to describe behavior changes, or time varying segments. Many statistical models are relatively immune to micro variations in workload behavior, and will identify macro changes in workload behavior to properly model behavioral shifts in system operation/workload. Thus, the period of time of trace 210 can be broken down into sub-periods of time, where each sub-period of time is represented by workload behavior that differs from either the sub-period before or after it (and thus represents a change in behavior). The sub-periods can be similar in duration, or can all be different.

In one embodiment, mapper 240 receives time varying segments generated by segmenter 230. Mapper 240 can map or translate a variable to a representation that is more manipulable in a trace model. For example, variables representing the various attributes of segments and/or of the trace can take on any of a number of different values, different ranges, different scales, and/or different variable type. In such a circumstance, system 200 can normalize and/or discretize the variables into “buckets” or standardized ranges/values that can be used to better evaluate and weight the variables with respect to each other. Mapping function 242 represents a function or rule used to map a variable to a standardized representation for a trace model. In one embodiment, one mapping function 242 exists for every variable 222. In an alternate embodiment, one mapping function 242 can be used for multiple variables 222. In one embodiment, mapper 240 applies mapping function 242 to the variables separately per segment.

Model generation 250 generates one or more models from the trace information processed by parser 220, segmenter 230, and mapper 240. In one embodiment, model generation 250 generates a separate model for each time varying segment. Model generation 250 can generate a model of trace 210 based on combining various segment models. Model 260 represents the one or more models generated by model generation 250. Model 260 can include segment models and/or a model of trace 210 generated from segments. Model generation 250 can store model 260 to disk or other memory resources for use by one or more other components, such as a trace rebuilder.

In one embodiment, model generation 250 includes logic to detect that there are multiple segments that represent statistically similar or the same system behavior or workload behavior. Such logic can be included, for example, in segmenter 230. When multiple segments represent similar system behavior, model generation 250 can eliminate one of the segments or reuse segments in generating a model. Thus, model generation 250 can generate a trace model by reusing one segment in place of using a detected segment. In one embodiment, another component of system 200 (which could be a component not shown) can detect and eliminate statistically duplicate segments.

The detection and elimination of segments can be thought of as starting with a set or group of segments as generated by segmenter 230 (and possibly mapper 240, which could help identify which segments are statistically similar by standardizing the variable representations). The group or set of segments represents a plurality of segments extracted from trace 210, which can be used to identify behavior of the trace for a sub-period of time. In response to detecting segments that have statistical similarity or are statistically identical, system 200 can reduce the working set of segments that will be used to create a trace model. Thus, the group of segments used to identify behavior of the trace can be reduced to a smaller number or reduced set of segments that can be used to accurately describe all system behavior over the period of the entire trace 210.

In one embodiment, model generation 250 can include logic to reduce the number of attributes or parameters used to define or describe workload behavior. Such logic can detect a statistical similarity in attributes, and select a single attribute as representative of many attributes that are calculated to be statistically redundant. By reducing the number of parameters used, statistical tools can be used to compute model representation(s) for the trace segments and the trace in much less time and with a much smaller model.

FIG. 3 is a block diagram of an embodiment of an architecture for trace modeling and playback. System 300 can be one example of a system in accordance with system 200 of FIG. 2. System 300 receives trace 310 at parser 320. Parser 320 parses elements of data within trace 310. In one embodiment, parser 320 translates a workload block trace into a standardized file format. In one embodiment, parser 320 includes variable logic 322 to identify attributes of workload behavior which parser 320 can identify in the parsing of the trace. In one embodiment, variable logic 322 receives variable definitions (e.g., receiving a definition by a user of system 300, retrieving definitions from a definition file, or receiving a definition as a parameter passed from an application that invokes one or more components of system 300).

Parser 320 sends the parsed trace file to segmenter 330, which can generate time varying segments derived from trace 310. Segmenter 330 receives the parsed trace as input and computes what elements of the trace indicate different time varying segments of the trace workload behavior.

In one embodiment, segmenter 330 includes autoregression (AR) logic 332 to perform a statistical analysis of the parsed trace to determine a statistical distribution of behavior indicated in the data. In one embodiment, AR logic 332 includes a Markov model to statistically compute the workload behavior attributes of trace 310. AR logic 332 can perform autoregression over each random variable that represents an aspect of the system behavior of trace 310 (where the system behavior or workload behavior refers to the behavior of computing system in which trace 310 was recorded). In one embodiment, AR logic 332 segments trace 310 automatically based on a statistical distance between corresponding autoregression coefficients. AR logic 332 segments a trace dynamically while accessing the trace. In one embodiment, AR logic 332 represents segment with similar/identical coefficients and degrees as segments of a same type, where the AR logic identifies types of segments within a trace.

In one embodiment, mapper 340 receives time varying segments generated by segmenter 330. Mapper 340 includes function logic 342 to map or translate a variable to a normalized and/or discretized representation for use in a trace model. Function logic 342 represents a function or rule used to map a variable to a standardized (normalized and/or discretized) representation. In one embodiment, function logic 342 represents execution of a mapping routine. There are typically multiple instances of function logic 342. In one embodiment, mapper 340 includes one instance of function logic 342 for every variable used to extract segment information from trace 310. Mapper 340 can thus discretize the various workload dimensions, such as operation type, seek distance, offset, or other parameters.

An instance refers to a copy of a source object or source code. An instance is created by instantiating the copy or instantiation. The source code can be a class, model, or template, and the instance is a copy that includes at least some overlap of a set of attributes, which can have different configuration or settings than the source. Additionally, modification of an instance can occur independent of modification of the source.

Model generation 350 generates one or more models from the trace information processed by parser 320, segmenter 330, and mapper 340. In one embodiment, model generation 350 generates a separate model for each time varying segment. Model generation 350 can generate a model of trace 310 based on combining various segment models. Model generation 350 stores model file information 360, which can be used to regenerate and/or create traces for execution. Model file 360 can include segment models and/or a model of trace 310 generated from segments.

In one embodiment, model generation 350 includes logic to detect that there are multiple segments that represent statistically similar or the same system behavior or workload behavior. When multiple segments represent similar system behavior, model generation 350 can eliminate one of the segments or reuse segments in generating a model. In one embodiment, system 300 includes MI (Mutual Information) logic 352, which enables model generation 350 to determine a statistical relationship between random variables of trace 310 to reduce dimensionality by eliminating redundant workload dimensions. In one embodiment, system 300 via MI logic 352 represents each attribute as a time varying signal. Thus, system 300 can represent the trace as trace segments, which are each time varying signals. Based on the statistical relationships, model generation 350 can use MI logic 352 reduce dimensionality of the parsed and segmented data of trace 310. Certain dimensions of the segments can be eliminated based on statistical similarity with other dimensions. MI logic 352 can be considered to measure entropy between two or more random variables or between time varying signal representations, where variables or signals that are within a predetermined threshold of entropy can be represented by a single signal representative of all the signals within the predetermined threshold.

In one embodiment, model generation 350 reduces dimensionality of the workload model by representing the redundant signals indicated by a high value of MI with a single representative signal. In one embodiment, model generation 350 reduces dimensionality of the data via an entropy calculation between two time varying segments as provided by MI logic 352. Model generation 350 can also reduce the number of unique attribute representations used to model the workloads, which allows building a concise workload model much faster with little to no information loss.

In one embodiment, model generation 350 includes clustering logic 354 to perform agglomerative clustering (such as hierarchical agglomerative clustering (HAC)). Agglomerative clustering refers to a statistical analysis of random variables that merges or agglomerates variables that are within a threshold of each other (usually referred to as a length based on the model set up for the variable space). In the case of agglomerative clustering of trace segments, clustering logic 354 can perform agglomerative clustering on the segments (where the segments are the random variables on which the agglomeration is performed). Clustering logic 354 can thus determine what segments can be merged, while still providing a high-fidelity representation of the behavior of the system as recorded in trace 310.

In one embodiment, model generation 350 includes distribution logic 356 to generate distributions of random variables, which can be stored as information in model file 360 in combination with segment model information. System 300 can use the information regarding distribution of random variables to regenerate I/O in a test case. In one embodiment, distribution logic 356 generates the distribution information via empirical probability distribution functions (PDFs) per random variable or attribute. Model generation 350 can use distribution information to determine how to combine time varying segments or signals that represent time varying segments into a model of desired system workload behavior.

System 300 includes regeneration logic 370 to generate an executable trace from model information generated by model generation 350 and stored in model file 360. Regeneration logic 370 reads the appropriate information from model file 360 to regenerate a desired workload from the time varying segments (and any distribution information that is stored). Regeneration logic 370 can alternatively be referred to as a regenerator. In one embodiment, regeneration logic 370 can be invoked separately of any of the existing workload models built by system 300. Regeneration logic 370 allows for modification or customization of a generated workload model. Thus, regeneration logic 370 provides for various workload what-if scenarios on the model without re-building the models.

Even though regeneration logic 370 can produce high fidelity workload regeneration, system 300 significantly reduces the space overhead incurred in storing I/O traces, as compared to storing the actual I/O traces. As discussed above, parser 320 analyzes the various I/O characteristics from trace 310, and segmenter 330, mapper 340, and model generation 350 build a statistical model of trace 310. In one embodiment, a user of system 300 provides a set of I/O characteristics of interest to parser 320. Seeing that system 300 builds a statistical workload model, regeneration logic 370 can include an equivalent interpreter 372 for replay. Interpreter 372 includes logic to build synthetic workloads or test traces from the statistical model information. The synthetic workloads or test traces simulate or emulate system behavior or behavior of workloads. Thus, regeneration logic 370 can generate a synthetic workload by reading the statistical model in memory (e.g., model file 360) and building a workload model from the information via interpreter 372.

It will be understood that model file 360 includes statistical information, and model representations of segments of original trace 310. Thus, the models are statistical in nature, rather than exact representations of the trace. For example, block traces captured via a SCSI (small computer system interface) network protocol or disk traces represent actual operations that occur within a system. Model information generated by model generation 350 is much smaller in size, and can be manipulated to allow several degrees of freedom during workload regeneration.

In one embodiment, regeneration logic 370 includes scaling logic 374 to allow scaling of workload operations. For example, scaling logic 374 can make changes to the timing of operations in a synthetic workload to provide inter arrival time scaling and/or total runtime scaling, and/or can make changes to storage locations/addresses affected by operations in a synthetic workload to provide storage space size (LUN (logical unit number)) scaling. In one embodiment, regeneration logic 370 includes multi-threading logic 376 to allow execution of a synthetic workload across multiple threads. In one embodiment, regeneration logic 370 includes logic to apply simultaneous multitenancy to a synthetic workload.

Thus, regeneration logic 370 can enable system 300 to generate a synthetic workload or test trace that simulates different workload behavior than what is recorded in trace 310. In one embodiment, the different behavior can include workloads not present in trace 310. In one embodiment, the different behavior can include workloads that were in trace 310, but executed in a different pattern. In one embodiment, the different behavior can include either workload behavior identified in trace 310 or workload behavior not identified in trace 310, but executed or replayed over a different time period from trace 310.

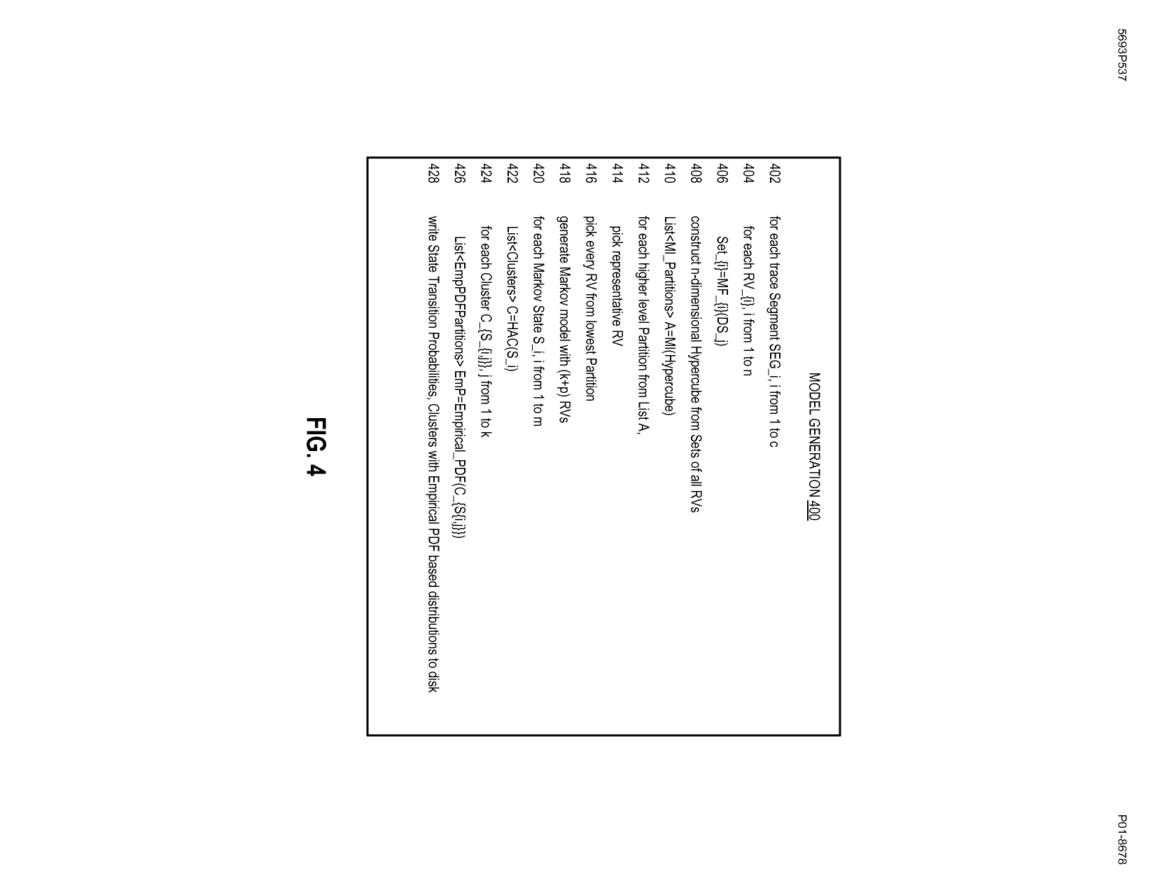

FIG. 4 is a pseudocode representation of an embodiment of a trace model generation. Model generation pseudocode 400 represents an embodiment of code structure for trace model generation, such as that provided in system 200 of FIG. 2 and/or system 300 of FIG. 3. It will be understood that pseudocode 400 could be implemented in any of a number of programming languages. Pseudocode 400 assumes that a source trace or original trace has already been analyzed to extract trace segments.

In one embodiment, in line 402, the code begins a loop that iterates for each trace segment, SEG_i, where i is a dimension index of value from 1 to c. In one embodiment, the segments are initially of a continuous variable, c, which can be different for each variable. Line 404 introduces a nested loop, where the code evaluates each random variable (RV) within a segment. The nested loop at line 406 passes each random variable within the given segment to a mapping function (MF), which can partition the range 1 to c into a suitable discretized number of buckets or ranges, from 1 to n. In line 406, the set of discretized variables, Set_{i} is created from the mapping function for a discretization size applicable to or corresponding with the random variable. Thus, code 400 discretizes each random variable from a continuous value 1 to c into a set or discretization group of values, RV_{i}, from 1 to n.

In one embodiment, the model generation logic represents the discretization data as an n-dimensional hypercube, with each dimension representing a random variable with its corresponding bucket index or indices. Thus, in one embodiment, as in line 408, the code constructs an n-dimensional hypercube from the discretized sets of the random variables. In one embodiment, the value in each cell of the hypercube signifies a total count of I/O requests seen in the entire workload segment with attribute values represented by the cell coordinates. In one embodiment, model generation logic (e.g., with logic separate from pseudocode 400) computes conditional probability distributions of a given random variable index over each of the indices of the other random variables. Computing such conditional probability distributions can prepare the data for evaluation based on Mutual Information.

In one embodiment, pseudocode 400 generates a Mutual Information (MI) list based on the random variables in the hypercube. It will be understood that other statistical approaches can be used to reduce dimensionality of the random variable data, and the hypercube and Mutual Information approach is simply one example. In line 410, the code generates a list A of partitions of data, List<MI_Partitions>, based on evaluating the hypercube for Mutual Information. For example, the code can leverage previously computed values of conditional probability distributions.

In one embodiment, pseudocode 400 normalizes the value of Mutual Information to lie between 0 and 1. Thus, random variable pairs with identical values of Mutual Information that share a common random variable can be grouped together as one partition of mutually dependent random variables. In one embodiment, the code orders the partitions based on Mutual Information value. The code can then enforce a threshold of sharing to determine when to merge partitions. Such a threshold can be set to reduce dimensionality, while not losing significant amounts of data for subsequent modeling/regeneration. For example, the code can represent each random variable as an Independent RV when the MI value is below the threshold. For random variables with an MI value above the threshold, the code can select one representative random variable.

In lines 412 and 414, the code iterates through each partition of List A that is higher than the threshold (“higher level Partition”), and selects a representative random variable. The higher level partitions are those that show high levels of sharing (as indicated by the threshold), and can be merged into the representative random variable representation. In line 416, the code selects every random variable of the lower partitions, which represent the least dependent random variables.

In one embodiment, the code generates a Markov model. In line 418, pseudocode 400 generates a Markov model with (k+p) random variables, where k represents the total number of higher order partitions and p represents the total number of independent random variables. The Markov model includes a number of states, S, where each state represents a particular range of values for each of the random variables. In one embodiment, the range of values for a given random variable may not be uniformly distributed, and the code can apply a distribution model to the range. The total number of states is m, which is a cross product of dimensionality of each chosen RV (i.e., the (k+p) random variables used to generate the Markov model).

In one embodiment, pseudocode 400 generates a list of clusters for hierarchical agglomerative clustering (HAC). In line 420, the code begins a loop that iterates through each Markov State, from 1 to m. In line 422, the code generates a list, C, of clusters by performing HAC for each state. The HAC can further partition range space of each random variable. In one embodiment, pseudocode 400 also generates empirical PDFs for each cluster. In line 424, the code begins a loop to iterate for each cluster within a set of states from 1 to k. In line 426, the code generates a list, EmP, of empirical PDF partitions by computing a probability distribution function for each state within the set of states for a given cluster. In line 428, pseudocode 400 writes the state transition probabilities and clusters with empirical PDF information to disk. For model generation, the model generation logic can provide statistical information that can then be used to regenerate respective random variables values in each state.

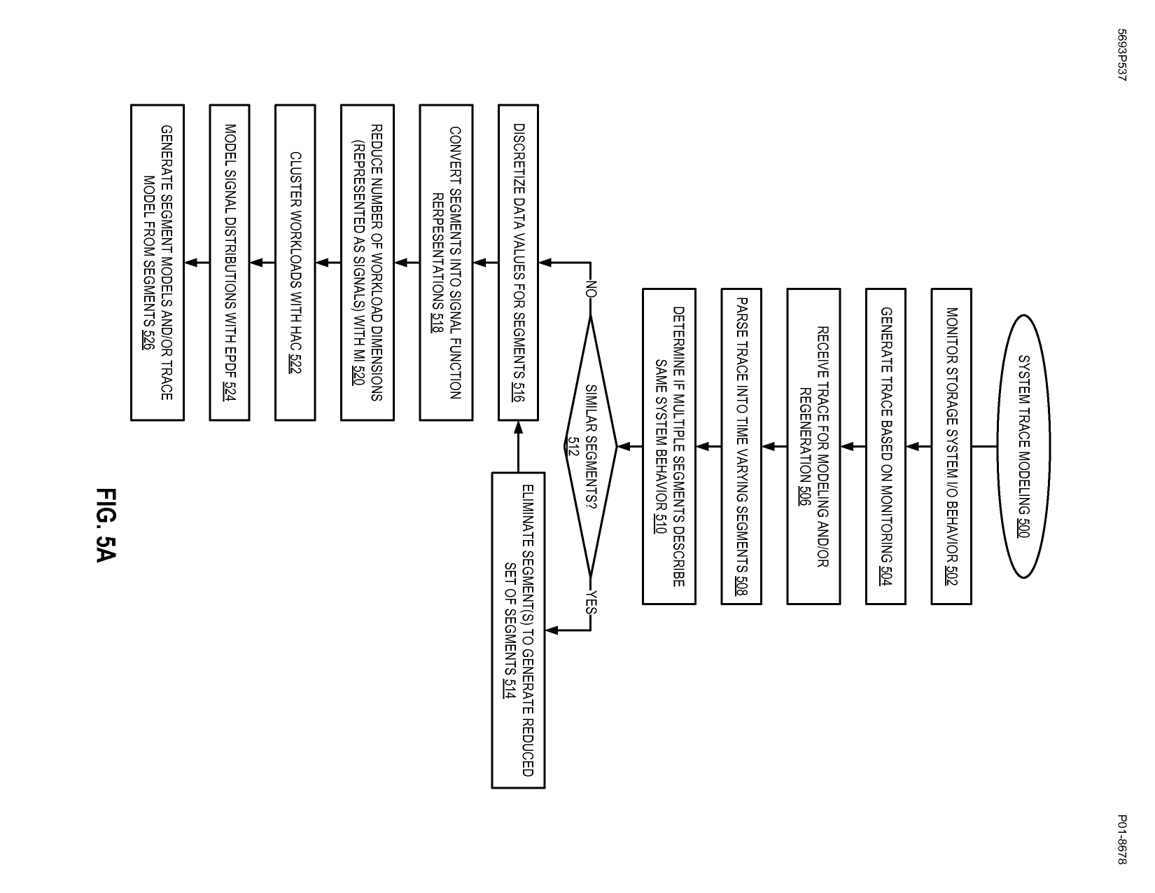

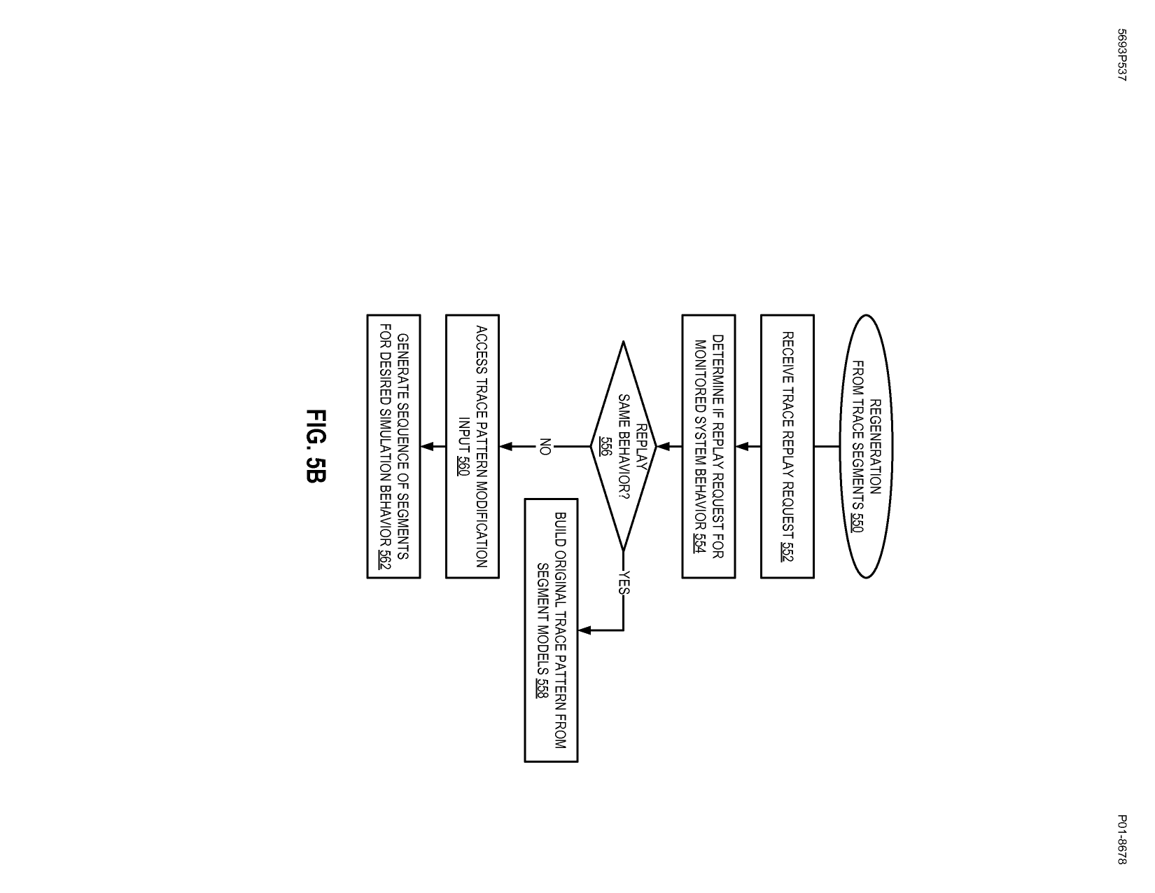

FIG. 5A is a flow diagram of an embodiment of a process 500 for modeling a trace with time varying segments. A trace creation system monitors behavior (e.g., I/O activity or operations) of a storage system, block 502. The trace creation system generates a source trace, 504, from which time varying trace segments can be extracted for model generation. A model generation system (such as systems 170, 200, or 300), which can be the same or different from the trace creation system, receives the original or source trace as input for modeling and/or regeneration, block 506.

The model generation system includes multiple components or logic elements that extract segment information, and analyze/process the information to create a model. A parser component parses the received trace into time varying segments, block 508, in accordance with any embodiment described above. The model generation system determines if multiple segments describe or represent the same or similar system behavior, block 510. The model generation system can employ any of a number of statistical tools to determine when segments are statistically the same or substantially equivalent enough to be considered the same.

If the model generation system finds segments that are within a statistical proximity of each other, block 512 YES branch, the model generation system can eliminate one or more segments to generate a reduced set of trace segments, block 514. In one embodiment, the model generation system selects a representative segment from among similar segments to represent the segment variable or attribute information. In one embodiment, when the model generation system does not find similar segments, block 512 NO branch, one or more other components of the model generation system discretize data values for the segments, block 516. In one embodiment, the model generation system converts the segments into signal function representations, block 518. Each attribute or characteristic of the trace or derived from the trace can be represented as a separate signal. Each segment can be represented as a combination of signals.

In one embodiment, the model generation system uses one or more (such as a combination) statistical techniques to reduce the dimensionality of the data for the model of the trace. The dimensionality refers to the number of workload attributes used to model the trace or trace segments. For example, the model generation system can reduce a number of signals used to represent the trace, such as with a Mutual Information calculation, 520. Thus, the system can reduce the number of workload dimensions used to represent the trace information. In one embodiment, the model generation system can use statistical clustering, such as hierarchical agglomerative clustering (HAC), to group workloads/workload behaviors, 522. In one embodiment, the model generation system can use empirical probability distribution functions (ePDFs) to model the distribution of signals or signal representations in workload models, 524. The model generation system generates segment model information and/or trace models from a set of segments represented within the system, block 526.

FIG. 5B is a flow diagram of an embodiment of a process 550 for replaying a trace or trace regeneration with time varying segments. The replaying the trace or trace segments can be referred to as simulating or emulating workload(s) or system behavior. In one embodiment, a model regeneration system (or model generation system that supports regeneration, such as system 300) receives a request to replay a trace, block 552. In one embodiment, the regeneration system can determine if the replay request is for monitored system behavior, 554. Depending on how the regeneration system is configured, it will not make any difference whether the request is for the same trace or a modified trace. In one embodiment, the “determining” can simply be determining if there are external variables or input that change the requested behavior of the replay from the recorded trace.

If request is for the regeneration system to replay the same workload behavior as the recorded trace, block 556 YES branch, the regeneration system build the original trace patter from stored segment models, block 558. If the request is to replay different workload behavior, block 556 NO branch, the regeneration system accesses trace modification input in addition to stored segment models, block 560. The regeneration system generates a sequence of segments to implement the desired simulated behavior, based on the input modifications, block 562. The regeneration system can then replay the trace as generated from segment models.

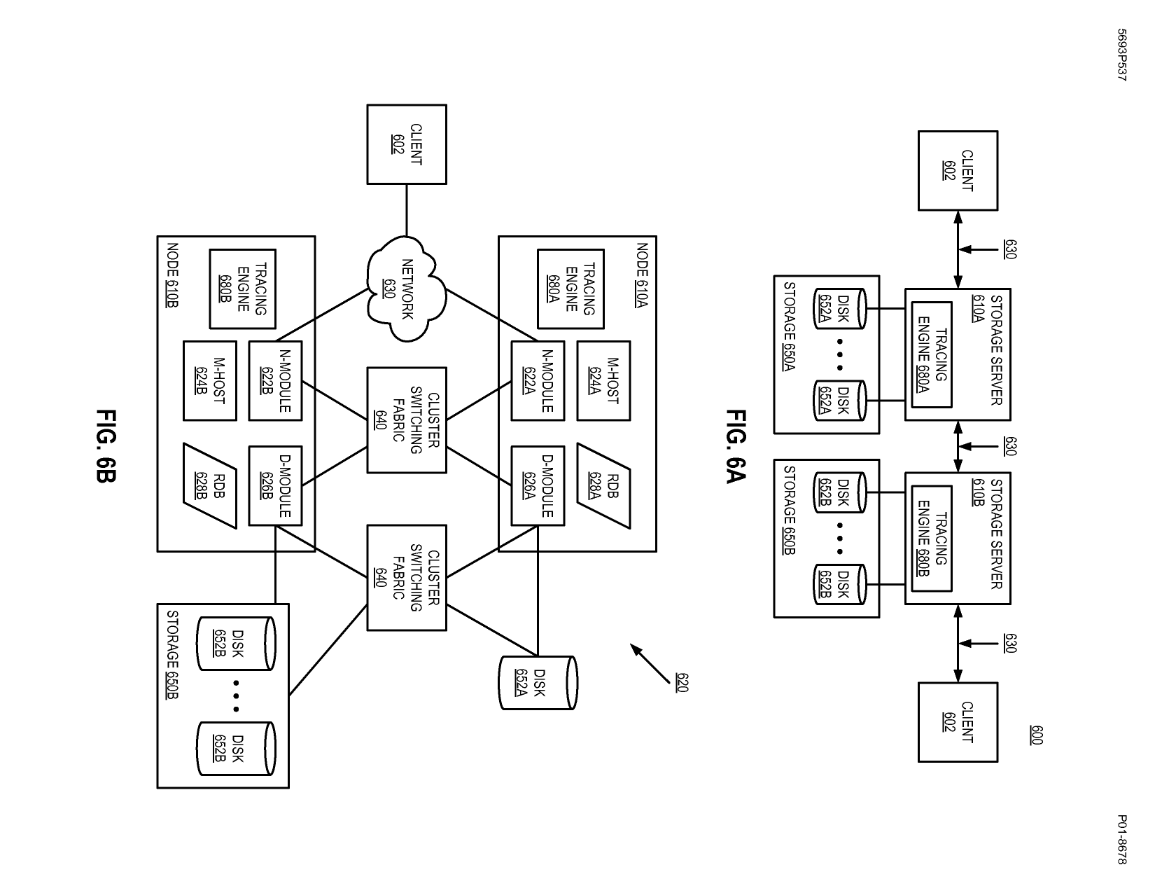

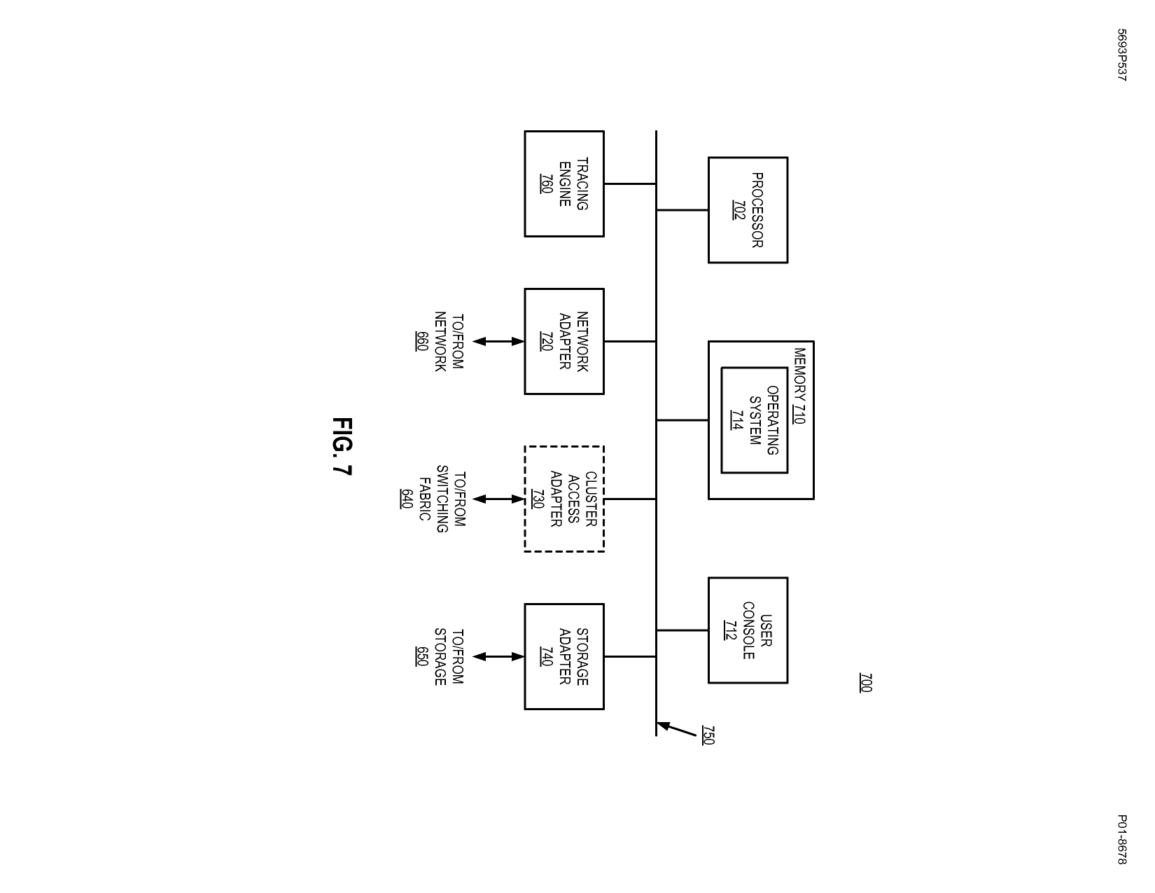

FIG. 6A illustrates a network storage system in which an architecture for trace modeling with time varying segments can be implemented. Storage servers 610 (storage servers 610A, 610B) each manage multiple storage units 650 (storage 650A, 650B) that include mass storage devices. These storage servers provide data storage services to one or more clients 602 through a network 630. Network 630 can be, for example, a local area network (LAN), wide area network (WAN), metropolitan area network (MAN), global area network such as the Internet, a Fibre Channel fabric, or any combination of such interconnects. Each of clients 602 can be, for example, a conventional personal computer (PC), server-class computer, workstation, handheld computing or communication device, or other special or general purpose computer.

Storage of data in storage units 650 is managed by storage servers 610 which receive and respond to various read and write requests from clients 602, directed to data stored in or to be stored in storage units 650. Storage units 650 constitute mass storage devices which can include, for example, flash memory, magnetic or optical disks, or tape drives, illustrated as disks 652 (652A, 652B). Storage devices 652 can further be organized into arrays (not illustrated) implementing a Redundant Array of Inexpensive Disks/Devices (RAID) scheme, whereby storage servers 610 access storage units 650 using one or more RAID protocols known in the art.

Storage servers 610 can provide file-level service such as used in a network-attached storage (NAS) environment, block-level service such as used in a storage area network (SAN) environment, a service which is capable of providing both file-level and block-level service, or any other service capable of providing other data access services. Although storage servers 610 are each illustrated as single units in FIG. 6A, a storage server can, in other embodiments, constitute a separate network element or module (an “N-module”) and disk element or module (a “D-module”). In one embodiment, the D-module includes storage access components for servicing client requests. In contrast, the N-module includes functionality that enables client access to storage access components (e.g., the D-module), and the N-module can include protocol components, such as Common Internet File System (CIFS), Network File System (NFS), or an Internet Protocol (IP) module, for facilitating such connectivity. Details of a distributed architecture environment involving D-modules and N-modules are described further below with respect to FIG. 6B and embodiments of a D-module and an N-module are described further below with respect to FIG. 8.

In one embodiment, storage servers 610 are referred to as network storage subsystems. A network storage subsystem provides networked storage services for a specific application or purpose, and can be implemented with a collection of networked resources provided across multiple storage servers and/or storage units.

In the embodiment of FIG. 6A, one of the storage servers (e.g., storage server 610A) functions as a primary provider of data storage services to client 602. Data storage requests from client 602 are serviced using disks 652A organized as one or more storage objects. A secondary storage server (e.g., storage server 610B) takes a standby role in a mirror relationship with the primary storage server, replicating storage objects from the primary storage server to storage objects organized on disks of the secondary storage server (e.g., disks 650B). In operation, the secondary storage server does not service requests from client 602 until data in the primary storage object becomes inaccessible such as in a disaster with the primary storage server, such event considered a failure at the primary storage server. Upon a failure at the primary storage server, requests from client 602 intended for the primary storage object are serviced using replicated data (i.e. the secondary storage object) at the secondary storage server.

It will be appreciated that in other embodiments, network storage system 600 can include more than two storage servers. In these cases, protection relationships can be operative between various storage servers in system 600 such that one or more primary storage objects from storage server 610A can be replicated to a storage server other than storage server 610B (not shown in this figure). Secondary storage objects can further implement protection relationships with other storage objects such that the secondary storage objects are replicated, e.g., to tertiary storage objects, to protect against failures with secondary storage objects. Accordingly, the description of a single-tier protection relationship between primary and secondary storage objects of storage servers 610 should be taken as illustrative only.

In one embodiment, system 600 includes tracing engine 680 (680A, 680B), which includes an architecture for trace modeling with time varying segments in accordance with any embodiment described above. Tracing engine 680 includes model generation logic to parse a trace into time varying segments, and reduce the information needed to represent the trace by eliminating segments that describe similar system behavior.

FIG. 6B illustrates a distributed or clustered architecture for a network storage system in which an architecture for trace modeling with time varying segments can be implemented in an alternative embodiment. System 620 can include storage servers implemented as nodes 610 (nodes 610A, 610B) which are each configured to provide access to storage devices 652. In FIG. 6B, nodes 610 are interconnected by a cluster switching fabric 640, which can be embodied as an Ethernet switch.

Nodes 610 can be operative as multiple functional components that cooperate to provide a distributed architecture of system 620. To that end, each node 610 can be organized as a network element or module (N-module 622A, 622B), a disk element or module (D-module 626A, 626B), and a management element or module (M-host 624A, 624B). In one embodiment, each module includes a processor and memory for carrying out respective module operations. For example, N-module 622 can include functionality that enables node 610 to connect to client 602 via network 630 and can include protocol components such as a media access layer, Internet Protocol (IP) layer, Transport Control Protocol (TCP) layer, User Datagram Protocol (UDP) layer, and other protocols known in the art.

In contrast, D-module 626 can connect to one or more storage devices 652 via cluster switching fabric 640 and can be operative to service access requests on devices 650. In one embodiment, the D-module 626 includes storage access components such as a storage abstraction layer supporting multi-protocol data access (e.g., Common Internet File System protocol, the Network File System protocol, and the Hypertext Transfer Protocol), a storage layer implementing storage protocols (e.g., RAID protocol), and a driver layer implementing storage device protocols (e.g., Small Computer Systems Interface protocol) for carrying out operations in support of storage access operations. In the embodiment shown in FIG. 6B, a storage abstraction layer (e.g., file system) of the D-module divides the physical storage of devices 650 into storage objects. Requests received by node 610 (e.g., via N-module 622) can thus include storage object identifiers to indicate a storage object on which to carry out the request.

Also operative in node 610 is M-host 624 which provides cluster services for node 610 by performing operations in support of a distributed storage system image, for instance, across system 620. M-host 624 provides cluster services by managing a data structure such as a relational database (RDB) 628 (RDB 628A, RDB 628B) which contains information used by N-module 622 to determine which D-module 626 “owns” (services) each storage object. The various instances of RDB 628 across respective nodes 610 can be updated regularly by M-host 624 using conventional protocols operative between each of the M-hosts (e.g., across network 630) to bring them into synchronization with each other. A client request received by N-module 622 can then be routed to the appropriate D-module 626 for servicing to provide a distributed storage system image.

Similar to what is described above, system 620 includes tracing engine 680 (680A, 680B), which includes an architecture for trace modeling with time varying segments in accordance with any embodiment described above. Tracing engine 680 includes model generation logic to parse a trace into time varying segments, and reduce the information needed to represent the trace by eliminating segments that describe similar system behavior.

It will be noted that while FIG. 6B shows an equal number of N- and D-modules constituting a node in the illustrative system, there can be different number of N- and D-modules constituting a node in accordance with various embodiments. For example, there can be a number of N-modules and D-modules of node 610A that does not reflect a one-to-one correspondence between the N- and D-modules of node 610B. As such, the description of a node comprising one N-module and one D-module for each node should be taken as illustrative only.

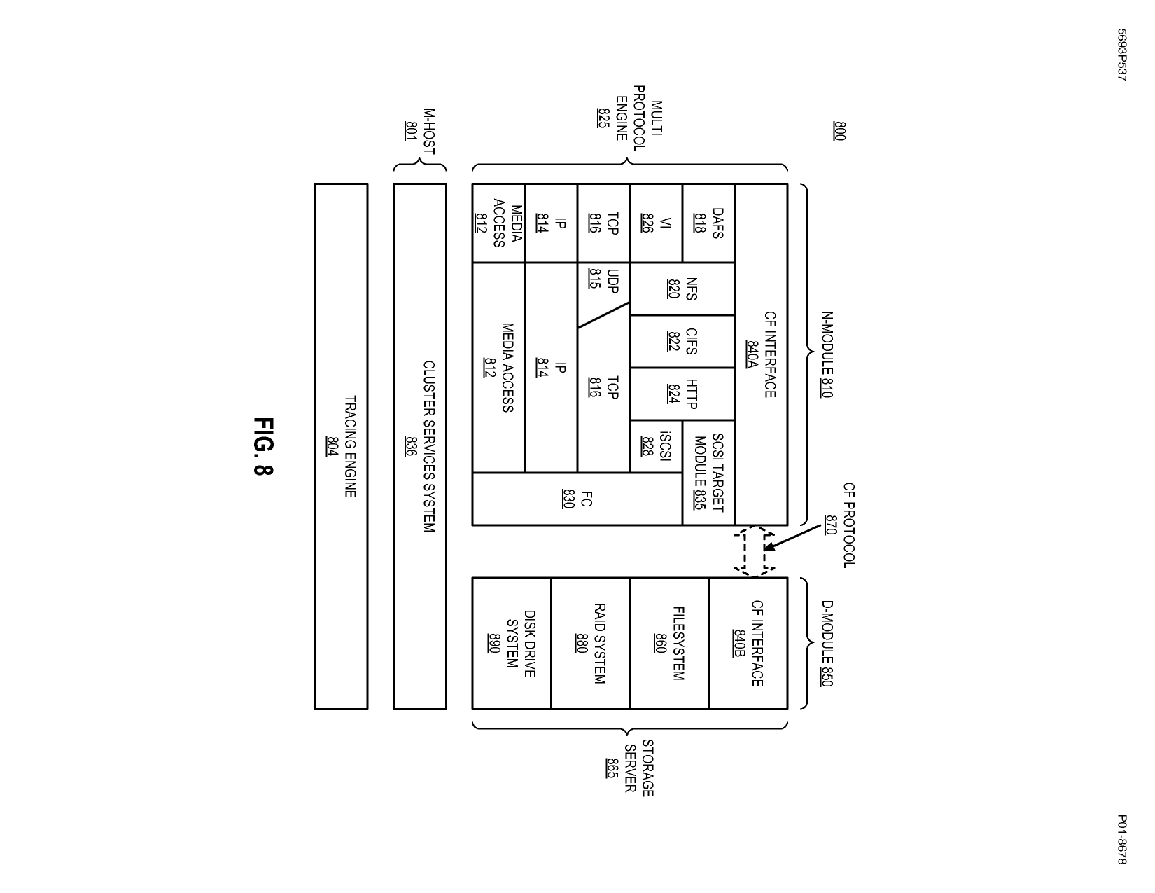

FIG. 7 is a block diagram of an illustrative embodiment of an environment of FIGS. 6A and 6B in which an architecture for trace modeling with time varying segments can be implemented. As illustrated, the storage server is embodied as a general or special purpose computer 700 including a processor 702, a memory 710, a network adapter 720, a user console 712 and a storage adapter 740 interconnected by a system bus 750, such as a convention Peripheral Component Interconnect (PCI) bus.

Memory 710 includes storage locations addressable by processor 702, network adapter 720 and storage adapter 740 for storing processor-executable instructions and data structures associated with a multi-tiered cache with a virtual storage appliance. A storage operating system 714, portions of which are typically resident in memory 710 and executed by processor 702, functionally organizes the storage server by invoking operations in support of the storage services provided by the storage server. It will be apparent to those skilled in the art that other processing means can be used for executing instructions and other memory means, including various computer readable media, can be used for storing program instructions pertaining to the inventive techniques described herein. It will also be apparent that some or all of the functionality of the processor 702 and executable software can be implemented by hardware, such as integrated currents configured as programmable logic arrays, ASICs, and the like.

Network adapter 720 comprises one or more ports to couple the storage server to one or more clients over point-to-point links or a network. Thus, network adapter 720 includes the mechanical, electrical and signaling circuitry needed to couple the storage server to one or more client over a network. Each client can communicate with the storage server over the network by exchanging discrete frames or packets of data according to pre-defined protocols, such as TCP/IP.

Storage adapter 740 includes a plurality of ports having input/output (I/O) interface circuitry to couple the storage devices (e.g., disks) to bus 750 over an I/O interconnect arrangement, such as a conventional high-performance, FC or SAS (Serial-Attached SCSI (Small Computer System Interface)) link topology. Storage adapter 740 typically includes a device controller (not illustrated) comprising a processor and a memory for controlling the overall operation of the storage units in accordance with read and write commands received from storage operating system 714. As used herein, data written by a device controller in response to a write command is referred to as “write data,” whereas data read by device controller responsive to a read command is referred to as “read data.”

User console 712 enables an administrator to interface with the storage server to invoke operations and provide inputs to the storage server using a command line interface (CLI) or a graphical user interface (GUI). In one embodiment, user console 712 is implemented using a monitor and keyboard.

In one embodiment, computing device 700 includes tracing engine 760, which includes an architecture for trace modeling with time varying segments in accordance with any embodiment described above. While shown as a separate component, in one embodiment, data tracing engine 760 is part of other components of computer 700. Tracing engine 760 includes model generation logic to parse a trace into time varying segments, and reduce the information needed to represent the trace by eliminating segments that describe similar system behavior.

When implemented as a node of a cluster, such as cluster 620 of FIG. 6B, the storage server further includes a cluster access adapter 730 (shown in phantom) having one or more ports to couple the node to other nodes in a cluster. In one embodiment, Ethernet is used as the clustering protocol and interconnect media, although it will be apparent to one of skill in the art that other types of protocols and interconnects can by utilized within the cluster architecture.

FIG. 8 is a block diagram of a storage operating system 800, such as storage operating system 714 of FIG. 7, in which an architecture for trace modeling with time varying segments can be implemented. The storage operating system comprises a series of software layers executed by a processor, such as processor 702 of FIG. 7, and organized to form an integrated network protocol stack or, more generally, a multi-protocol engine 825 that provides data paths for clients to access information stored on the storage server using block and file access protocols.

Multi-protocol engine 825 includes a media access layer 812 of network drivers (e.g., gigabit Ethernet drivers) that interface with network protocol layers, such as the IP layer 814 and its supporting transport mechanisms, the TCP layer 816 and the User Datagram Protocol (UDP) layer 815. The different instances of access layer 812, IP layer 814, and TCP layer 816 are associated with two different protocol paths or stacks. A file system protocol layer provides multi-protocol file access and, to that end, includes support for the Direct Access File System (DAFS) protocol 818, the NFS protocol 820, the CIFS protocol 822 and the Hypertext Transfer Protocol (HTTP) protocol 824. A VI (virtual interface) layer 826 implements the VI architecture to provide direct access transport (DAT) capabilities, such as RDMA, as required by the DAFS protocol 818. An iSCSI driver layer 828 provides block protocol access over the TCP/IP network protocol layers, while a FC driver layer 830 receives and transmits block access requests and responses to and from the storage server. In certain cases, a Fibre Channel over Ethernet (FCoE) layer (not shown) can also be operative in multi-protocol engine 825 to receive and transmit requests and responses to and from the storage server. The FC and iSCSI drivers provide respective FC- and iSCSI-specific access control to the blocks and, thus, manage exports of luns (logical unit numbers) to either iSCSI or FCP or, alternatively, to both iSCSI and FCP when accessing blocks on the storage server.

The storage operating system also includes a series of software layers organized to form a storage server 865 that provides data paths for accessing information stored on storage devices. Information can include data received from a client, in addition to data accessed by the storage operating system in support of storage server operations such as program application data or other system data. Preferably, client data can be organized as one or more logical storage objects (e.g., volumes) that comprise a collection of storage devices cooperating to define an overall logical arrangement. In one embodiment, the logical arrangement can involve logical volume block number (vbn) spaces, wherein each volume is associated with a unique vbn.

File system 860 implements a virtualization system of the storage operating system through the interaction with one or more virtualization modules (illustrated as a SCSI target module 835). SCSI target module 835 is generally disposed between drivers 828, 830 and file system 860 to provide a translation layer between the block (lun) space and the file system space, where luns are represented as blocks. In one embodiment, file system 860 implements a WAFL (write anywhere file layout) file system having an on-disk format representation that is block-based using, e.g., 4 kilobyte (KB) blocks and using a data structure such as index nodes or indirection nodes (“inodes”) to identify files and file attributes (such as creation time, access permissions, size and block location). File system 860 uses files to store metadata describing the layout of its file system, including an inode file, which directly or indirectly references (points to) the underlying data blocks of a file.

Operationally, a request from a client is forwarded as a packet over the network and onto the storage server where it is received at a network adapter. A network driver such as layer 812 or layer 830 processes the packet and, if appropriate, passes it on to a network protocol and file access layer for additional processing prior to forwarding to file system 860. There, file system 860 generates operations to load (retrieve) the requested data from the disks if it is not resident “in core”, i.e., in memory 710. If the information is not in memory, file system 860 accesses the inode file to retrieve a logical vbn and passes a message structure including the logical vbn to the RAID system 880. There, the logical vbn is mapped to a disk identifier and device block number (disk, dbn) and sent to an appropriate driver of disk driver system 890. The disk driver accesses the dbn from the specified disk and loads the requested data block(s) in memory for processing by the storage server. Upon completion of the request, the node (and operating system 800) returns a reply to the client over the network.

It should be noted that the software “path” through the storage operating system layers described above needed to perform data storage access for the client request received at the storage server adaptable to the teachings of the invention can alternatively be implemented in hardware. That is, in an alternate embodiment of the invention, a storage access request data path can be implemented as logic circuitry embodied within a field programmable gate array (FPGA) or an application specific integrated circuit (ASIC). This type of hardware embodiment increases the performance of the storage service provided by the storage server in response to a request issued by a client. Moreover, in another alternate embodiment of the invention, the processing elements of adapters 720, 740 can be configured to offload some or all of the packet processing and storage access operations, respectively, from processor 702, to increase the performance of the storage service provided by the storage server. It is expressly contemplated that the various processes, architectures and procedures described herein can be implemented in hardware, firmware or software.

When implemented in a cluster, data access components of the storage operating system can be embodied as D-module 850 for accessing data stored on disk. In contrast, multi-protocol engine 825 can be embodied as N-module 810 to perform protocol termination with respect to a client issuing incoming access over the network, as well as to redirect the access requests to any other N-module in the cluster. A cluster services system 836 can further implement an M-host (e.g., M-host 801) to provide cluster services for generating information sharing operations to present a distributed file system image for the cluster. For instance, media access layer 812 can send and receive information packets between the various cluster services systems of the nodes to synchronize the replicated databases in each of the nodes.

In addition, a cluster fabric (CF) interface module 840 (CF interface modules 840A, 840B) can facilitate intra-cluster communication between N-module 810 and D-module 850 using a CF protocol 870. For instance, D-module 850 can expose a CF application programming interface (API) to which N-module 810 (or another D-module not shown) issues calls. To that end, CF interface module 840 can be organized as a CF encoder/decoder using local procedure calls (LPCs) and remote procedure calls (RPCs) to communicate a file system command between D-modules residing on the same node and remote nodes, respectively.

In one embodiment, tracing engine 804 includes an architecture for trace modeling with time varying segments in accordance with any embodiment described above. In one embodiment, tracing engine 804 is implemented on existing functional components of a storage system in which operating system 800 executes. Tracing engine 804 includes model generation logic to parse a trace into time varying segments, and reduce the information needed to represent the trace by eliminating segments that describe similar system behavior.

As used herein, the term “storage operating system” generally refers to the computer-executable code operable on a computer to perform a storage function that manages data access and can implement data access semantics of a general purpose operating system. The storage operating system can also be implemented as a microkernel, an application program operating over a general-purpose operating system, or as a general-purpose operating system with configurable functionality, which is configured for storage applications as described herein.

As used herein, instantiation refers to creating an instance or a copy of a source object or source code. The source code can be a class, model, or template, and the instance is a copy that includes at least some overlap of a set of attributes, which can have different configuration or settings than the source. Additionally, modification of an instance can occur independent of modification of the source.

Flow diagrams as illustrated herein provide examples of sequences of various process actions. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various operations or functions are described herein, which can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communications interface to send data via the communications interface. A machine readable medium or computer readable medium can cause a machine to perform the functions or operations described, and includes any mechanism that provides (i.e., stores and/or transmits) information in a form accessible by a machine (e.g., computing device, electronic system, or other device), such as via recordable/non-recordable storage media (e.g., read only memory (ROM), random access memory (RAM), magnetic disk storage media, optical storage media, flash memory devices, or other storage media) or via transmission media (e.g., optical, digital, electrical, acoustic signals or other propagated signal). A communication interface includes any mechanism that interfaces to any of a hardwired, wireless, optical, or other medium to communicate to another device, such as a memory bus interface, a processor bus interface, an Internet connection, a disk controller. The communication interface can be configured by providing configuration parameters and/or sending signals to prepare the communication interface to provide a data signal describing the software content.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations without departing from their scope. Therefore, the illustrations and examples herein should be construed in an illustrative, and not a restrictive sense.

What is claimed is:

1. A method for system workload behavior modeling, comprising:
receiving a trace identifying behavior for system workloads over a period of time;
parsing the trace into time varying segments, where each segment represents system behavior for a sub-period of time, different from system behavior for adjacent sub-periods of time;
detecting time varying segments that represent statistically similar system behavior, and in response to detecting time varying segments that represent similar system behavior, selecting one of the time varying segments and eliminating at least one other time varying segment to create a reduced set of time varying segments; and
generating from the reduced set of time varying segment models that represent system behavior.

2. The method of claim 1, wherein the trace identifies I/O (input/output) requests to a storage system for the period of time.

3. The method of claim 1, further comprising:
discretizing the time varying segments.

4. The method of claim 1, further comprising:
converting the time varying segments into a signal representation.

5. The method of claim 1, wherein selecting one of the time varying segments and eliminating at least one other time varying segment comprises:
calculating autoregression coefficients for two time varying segments; and
eliminating one of the time varying segments when the autoregression coefficients between the two time varying segments is within a threshold.

6. The method of claim 1, wherein generating segment models further comprises:
calculating a Mutual Information measurement for attributes of the trace; and
eliminating redundant attributes when the Mutual Information indicates similarity between attributes that is within a threshold.

7. The method of claim 1, further comprising:
generating a test trace from the trace model, wherein the test trace when executed simulates system operation.

8. The method of claim 7, further comprising:
generating the test trace to simulate workload behavior of the system different than identified in the received trace.

9. The method of claim 8, wherein generating the test trace to simulate different workload behavior further comprises:
generating the test trace to simulate workloads not present in the received trace.

10. The method of claim 8, wherein generating the test trace to simulate different workload behavior further comprises:
generating the test trace to simulate workload patterns not present in the received trace.

11. The method of claim 8, wherein generating the test trace to simulate different workload behavior further comprises:
generating the test trace to simulate identified workload behavior over a different period of time.

12. A server device of a storage system, comprising:
a hardware interface to monitor and record system workload behavior for a period of time;
a memory device coupled to the hardware interface to store a source trace identifying the system workload behavior for the period of time; and
model generation logic coupled to the memory device to
parse the source trace into time varying segments, where each segment represents system workload behavior for a sub-period of time, different from system workload behavior for adjacent sub-periods of time;
detect time varying segments that represent statistically similar system workload behavior, and in response to detecting time varying segments that represent similar system workload behavior, selecting one of the time varying segments and eliminating at least one other time varying segment to create a reduced set of time varying segments; and
generate from the reduced set of time varying segments, segment models that represent system workload behavior.

13. The server device of claim 12, wherein the model generation logic is to further discretize the time varying segments.

14. The server device of claim 12, wherein the model generation logic is to parse the source trace via autoregression.

15. The server device of claim 12, wherein the model generation logic is to generate the segment models via applying a Markov model to the reduced set of time varying segments.

16. The server device of claim 12, wherein the model generation logic is to further generate a synthetic workload the segment models, wherein the synthetic workload when executed simulates system operation.

17. An article of manufacture comprising a computer-readable storage medium having content stored thereon, which when accessed by a server device causes the server device to perform operations including:
receiving a trace identifying behavior for system workloads over a period of time;
parsing the trace into time varying segments, where each segment represents system behavior for a sub-period of time, different from system behavior for adjacent sub-periods of time;
detecting time varying segments that represent statistically similar system behavior, and in response to detecting time varying segments that represent similar system behavior, selecting one of the time varying segments and eliminating at least one other time varying segment to create a reduced set of time varying segments; and
generating from the reduced set of time varying segment models that represent system behavior.

18. The article of manufacture of claim 17, wherein the content for selecting one of the time varying segments and eliminating at least one other time varying segment comprises content for
selecting a representative time varying segment based on a statistical threshold of similarity between time varying segments.

19. The article of manufacture of claim 17, further comprising content for
generating a test trace from the trace model, wherein the test trace when executed simulates system operation.

20. The article of manufacture of claim 17, wherein the content for generating the test trace to simulate different workload behavior further comprises content for
generating the test trace to simulate workload behavior of the system different than identified in the received trace.
